(19) United States
(12) Patent Application Publication
(10) Pub. No.: US 2024/0209233 A1
(43) Pub. Date: Jun. 27, 2024

(54) USE OF SOLID-BASED FOAMING AIDS IN AQUEOUS POLYURETHANE DISPERSIONS

(71) Applicant: Evonik Operations GmbH, Essen (DE)

(72) Inventors: Michael Klostermann, Essen (DE); Kai-Oliver Feldmann, Essen (DE); Marvin Jansen, Essen (DE)

(73) Assignee: Evonik Operations GmbH, Essen (DE)

(21) Appl. No.: 18/557,347

(22) PCT Filed: Apr. 28, 2022
(86) PCT No.: PCT/EP2022/061317

§ 371 Date: Oct. 26, 2023

(30) Foreign Application Priority Data
Apr. 30, 2021 (EP) 21171461.3

(51) Int. Cl. C09D 175/08; C08J 9/00; C08J 9/30; C09D 5/28; C09D 7/62

(52) U.S. Cl. CPC C09D 175/08; C08J 9/0066; C08J 9/009; C08J 9/30; C09D 5/28; C09D 7/62; C08J 2375/08

(57) ABSTRACT

Solid-based foaming aids can be used as additives in aqueous polymer dispersions for producing porous polymer coatings, preferably for producing porous polyurethane coatings.

The present invention is in the field of plastics coatings and imitation leathers.

It relates more particularly to the production of porous polymer coatings, preferably porous polyurethane coatings, using solids-based foaming aids that have preferably been hydrophobized.

Textiles coated with plastics, for example imitation leathers, generally consist of a textile carrier onto which is laminated a porous polymer layer which has in turn been coated with a top layer or a topcoat.

The porous polymer layer in this context preferably has pores in the micrometre range and is air-permeable and hence breathable, i.e. permeable to water vapour, but water-resistant. The porous polymer layer often comprises porous polyurethane. For environmentally friendly production of PU-based imitation leather, a method based on aqueous polyurethane dispersions, called PUDs, has been developed some time ago. These generally consist of polyurethane microparticles dispersed in water; the solids content is usually in the range of 30-60% by weight. For production of a porous polyurethane layer, these PUDs are mechanically foamed, coated onto a carrier (layer thicknesses typically between 300-2000 μm) and then dried at elevated temperature. During this drying step, the water present in the PUD system evaporates, which results in formation of a film of the polyurethane particles. In order to further increase the mechanical strength of the film, it is additionally possible to add particular hydrophilic isocyanates or carbodiimides to the PUD system during the production process, and these can react with free OH groups present on the surface of the polyurethane particles during the drying step, thus leading to additional crosslinking of the polyurethane film.

Both the mechanical and the tactile properties of PUD coatings thus produced are determined to a crucial degree by the cell structure of the porous polyurethane film. In addition, the cell structure of the porous polyurethane film affects the air permeability and breathability of the material. Particularly good properties can be achieved here with very fine, homogeneously distributed cells. A customary way of influencing the cell structure during the above-described production process is to add foam stabilizers to the PUD system before or during the mechanical foaming. A first effect of appropriate stabilizers is that sufficient amounts of air can be beaten into the PUD system during the foaming operation. Secondly, the foam stabilizers have a direct effect on the morphology of the air bubbles produced. The stability of the air bubbles is also influenced to a crucial degree by the type of stabilizer. This is important especially during the drying of foamed PUD coatings, since it is possible in this way to prevent drying defects such as cell coarsening or drying cracks.

Various foam stabilizers have already been used in the past in the above-described PUD process. Document US 2015/0284902 A1 or US 2006 0079635 A1, for example, describes the use of ammonium stearate-based roam stabilizers. However, the use of corresponding ammonium stearate-based stabilizers is associated with a number of drawbacks. A significant drawback here is that ammonium stearate has a very high migration capacity in the finished imitation leather. The effect of this is that surfactant molecules accumulate at the surface of the imitation leather with time, which can result in white discoloration at the leather surface. Furthermore, this surfactant migration can result in a greasy film that is perceived as unpleasant on the surface of the imitation leather, especially when corresponding materials come into contact with water.

A further drawback of ammonium stearate is that it forms insoluble lime soaps on contact with hard water. In the case of contact of imitation leather produced on the basis of ammonium stearate with hard water, white efflorescence can thus arise at the imitation leather surface, which is undesirable especially in the case of dark-coloured leather.

Yet another drawback of ammonium stearate-based foam stabilizers is that they do permit efficient foaming of aqueous polyurethane dispersions, but often lead to quite a coarse and irregular foam structure. This can have an adverse effect on the optical and tactile properties of the finished imitation leather.

Yet another drawback of ammonium stearate is that the PUD foams produced often have inadequate stability, which can lead to drawbacks in the processing thereof, especially in the drying of the PUD foams at elevated temperatures. A consequence of this would be, for example, that corresponding roams have to be dried relatively gently and slowly, which in turn leads to longer process times in imitation leather production.

As an alternative to ammonium stearate-based foam stabilizers, polyol esters and polyol ethers were identified in the past as effective foam additives for aqueous polyurethane dispersions. These structures are described, for example, in documents EP 3487945 A1 and WO2019042696A1. Compared to ammonium stearate, polyol esters and polyol ethers have the major advantage that they migrate only slightly, if at al, in the finished imitation leather and hence do not lead to unwanted surface discoloration. Moreover, polyol esters and polyol ethers are not sensitive to hard water.

A further advantage of polyol esters and polyol ethers over ammonium stearate-based foam stabilizers is additionally that they often lead to a distinctly finer and more homogeneous foam structure, which has advantageous effects on the properties or imitation leather materials produced with these substances. Polyol esters and polyol ethers often also lead to much more stable PUD foams, which in turn brings process-related advantages in imitation leather production.

In spite of these advantages, polyol esters and polyol ethers are also not entirely free of potential drawbacks. A potential drawback here is that the foam-stabilizing effect of these compound classes can be impaired under some circumstances by the presence of further cosurfactants present in the PUD system. Especially in the production of aqueous polyurethane dispersions, however, the use of cosurfactants is not unusual. Cosurfactants are used in this context for improved dispersion of polyurethane prepolymers in water and generally remain in the final product. During the mechanical foaming of aqueous polyurethane dispersions containing polyol esters or polyol ethers as foam additives, corresponding cosurfactants can have adverse effects on the foaming characteristics of the system under some circumstances. As a result, under some circumstances, it is often possible for only little air, if any at all, to be beaten into the system; this could be detrimental to the resultant foam structure. Cosurfactants can also have an adverse effect on the stability of the foams produced, which can result in foam ageing during the processing of the foamed PUD system, which in turn leads to faults and defects in the foam coatings produced.

A further potential drawback is that PUD systems containing polyol esters or polyol ethers as foam additives often require very high shear energies for efficient foaming. This in turn can entail limitations and process-related drawbacks under some circumstances.

The problem addressed by the present invention was therefore that of providing additives for production of PUD-based foam systems and foam coatings that enable efficient foaming of PUD systems and do not have the drawbacks detailed in the art. It has been found that, surprisingly, solids-based foaming aids enable the solution of the stated problem.

The present invention therefore provides for the use of solids-based foaming aids as additives in aqueous polymer dispersions, preferably aqueous polyurethane dispersions, for production of porous polymer coatings, preferably for production of porous polyurethane coatings.

The porous polymer layer to be produced in accordance with the invention (i.e. the porous polymer coating; these terms are used synonymously) here preferably has pores in the micrometre range, the mean cell size preferably being less than 350 μm, preferably less than 200 μm, especially preferably less than 150 μm, most preferably less than 100 μm. The preferred layer thickness is in the range of 10-10 000 μm, preferably of 50-5000 μm, further preferably of 75-3000 μm, especially of 100-2500 μm. The average cell size can preferably be determined by microscopy, preferably by electron microscopy, as elucidated further down.

The inventive use of solids-based foaming aids surprisingly has various advantages here.

One advantage is that solids-based roaming aids enable particularly efficient foaming of aqueous PUD systems. The foams thus produced are notable here for an exceptionally fine pore structure with particularly homogeneous cell distribution, which in turn has a very advantageous effect on the mechanical and tactile properties of the porous polymer coatings which are produced on the basis of these foams. In addition, it is possible in this way to improve the air permeability and breathability of the coating.

A further advantage is that solids-based foaming aids, even at relatively low shear rates, enable efficient foaming of PUD systems, which leads to fewer limitations and broader processability during imitation leather production.

Yet another advantage is that solids-based foaming aids enable the production of particularly stable foams. This firstly has an advantageous effect on their processability. Secondly, the elevated foam stability has the advantage that, during the drying of corresponding foams, drying defects such as cell coarsening or drying cracks can be avoided. Furthermore, the improved foam stability enables quicker drying of the foams, which offers processing advantages both from an environmental and from an economic point of view.

Yet another advantage is that the efficacy of solids-based foaming aids is barely impaired, if at all, by cosurfactants optionally present in the PUD system. Thus, the solids-based foaming aids according to the invention, even in the case of cosurfactant-containing PUD systems, enable efficient foaming of the system, and the formation of fine and homogeneous foams that are simultaneously extremely stable.

Yet another advantage is that the solids-based foaming aids according to the invention, in the finished imitation leather, have no migration capacity and thus do not lead to unwanted surface discoloration or efflorescence. Furthermore, the surfactants according to the invention are barely sensitive to hard water, if at all.

The term “solids-based foaming aids” throughout the present invention especially encompasses foaming aids consisting of particles that are insoluble in the aqueous polymer dispersion, preference being given both to organic and to inorganic particles. It is synonymous with the term “particulate foaming aid”. The term “particles” encompasses both rigid non-swellable particles and deformable swellable particles, wherein particles may be charged or uncharged in both cases. What is meant by “insoluble” in this context is that, within the temperature range of 0-100° C., over a period of 60 minutes, less than 5% by weight, preferably less than 2.5% by weight, even more preferably less than 1% by weight, of the particles dissolves in the polymer dispersion. In the context of the present invention, preference is given especially to those particles having a hydrophobized or partly hydrophobized surface. This is a very particularly preferred embodiment of the invention.

The term “hydrophobization” is known per se to the person skilled in the art. This is understood to mean, as is also the case in the context of this invention, the treatment or substances with what are called hydrophobizing agents in order to improve their wettability with water. Corresponding hydrophobizing agents can be adsorbed here on the surface of the substances to be treated. In the case of fully hydrophobized substances, the entire surface is covered with hydrophobizing agent, whereas, in the case of partly hydrophobized substances, only part of its surface has been modified with hydrophobizing agents. The term “hydrophobization” in the context of this invention also includes partial hydrophobization. Thus, if reference is made hereinafter to “hydrophobization” or “hydrophobized”, this also includes “partial hydrophobization” or “partly hydrophobized”, even if there should be no explicit mention thereof.

The hydrophobization in the context of this invention may preferably be effected by (reversible) adsorption and/or by (permanent) covalent attachment of suitable hydrophobizing agents to the particle surface. Preference is given here especially to those hydrophobized particles that have a uniformly hydrophobized surface and are not Janus particles. The term “Janus particle” is known to those skilled in the art.

The term “cosurfactant” over the entire scope of the present invention encompasses surfactants that may optionally be present in the polymer dispersion alongside the solids-based foaming aids according to the invention. These especially include surfactants that may be used during the production or the polymer dispersion. For example, polyurethane dispersions are often produced by synthesis of a PU prepolymer which, in a second step, is dispersed in water and then reacted with a chain extender. For improved dispersion of the prepolymer in water, it is possible here to use cosurfactants. In the context of the present invention, the cosurfactants are preferably anionic cosurfactants.

The invention is described further and by way of example hereinafter, without any intention that the invention be restricted to these illustrative embodiments. Where ranges, general formulae or compound classes are specified below, these are intended to include not only the corresponding ranges or groups of compounds which are explicitly mentioned but also all subranges and subgroups of compounds which can be obtained by removing individual values (ranges) or compounds. Where documents are cited in the context of the present description, the entire content thereof, particularly with regard to the subject matter that forms the context in which the document has been cited, is fully incorporated into the disclosure content of the present invention. Percentages are unless otherwise stated in percent by weight. Where parameters that have been determined by measurement are given hereinbelow, the measurements have been carried out at a temperature of 25° C. and a pressure of 101 325 Pa, unless otherwise stated. Where chemical (empirical) formulae are used in the present invention, the specified indices can be not only absolute numbers but also average values. For polymeric compounds, the indices preferably represent average values. Structural and empirical formulae presented in the present invention are representative of all isomers that are possible by differing arrangement of the repeating units.

In the context of the present invention, solids-based foaming aids used may either be organic or inorganic particles, and it is also possible to use mixtures of two or more particles. The particles used as foaming aids may be of natural or synthetic origin. Preferred organic particles here are cellulose, cellulose derivatives, chemical pulp, lignin, polysaccharides, wood fibres, sawdust, ground plastics, textile fibres and/or synthetic polymer particles, for example latex or polyurethane particles. Preferred inorganic particles are selected from the group of the (mixed) oxides/hydroxides, for example silicon oxide, aluminium oxide, zirconium oxide, silicon aluminium oxide, silica, aluminium/magnesium hydroxide or ground quartz, from the group of the carbonates, for example calcium carbonate or chalk, from the group of the phosphates, from the group of the sulfates, for example calcium sulfate or barium sulfate, and from the group of the silicates, for example talc, mica or kaolin, and/or from the group of the silicone-based particles, especially silicone resin-based or MQ resin-based particles, with very particular preference for oxides based on silicon oxide and/or aluminium oxide and silicates, especially kaolin.

In the context of the present invention, preference is given to using those particles as solids-based foaming aids that have an average volume-weighted primary particle size in the range of 0.01-100 μm, preferably in the range of 0.05-50 μm, more preferably in the range of 0.1-35 μm. The term “primary particle size” here describes the number of individual, non-aggregated or agglomerated particles. The term is known to those skilled in the art. The average primary particle size can be determined here by methods familiar to the person skilled in the art. Preferred methods here are laser diffraction or dynamic light scattering. Measurements by means of laser diffraction can be conducted, for example, with a MasterSizer 3000 from Malvern, and measurements by means of dynamic light scattering, for example, with a ZetaSizer Nano ZSP, likewise from Malvern.

As described above, it is very particularly preferred in the context of the present invention when the particles used as foaming aids are hydrophobized or partly hydrophobized, where (partial) hydrophobization can be effected by (reversible) adsorption and/or by (permanent) covalent attachment of suitable hydrophobizing agents. The choice of a suitable hydrophobization is guided here especially by the surface properties of the particles to be hydrophobized.

If the particles have negative (partial) charges at the surface, preference is given especially to those hydrophobization agents that bear cationic or partially cationic anchor groups. If the particles have positive (partial) charges at the surface, preference is given especially to those hydrophobization agents that bear anionic or partially anionic anchor groups.

The surface charge of the particles can be ascertained, for example, by determining the zeta potential. Corresponding measurements are known to the person skilled in the art and are possible, for example, with a ZetaSizer Nano ZSP from Malvern. As well as electrostatic interactions, attachment of suitable hydrophobizing agents is also possible by means of hydrogen bonds, dipole-dipole interactions, van der Waals interactions and coordinate or covalent bonds.

Preferred hydrophobizing agents, according to the surface characteristics of the particles to be hydrophobized, may be selected from the group of the cationic polymers, from the group of the amines, preferably from the group of the alkylamines or cations thereof, from the group of the quaternary ammonium compounds, preference being given both to organic and to silicone-based amine and ammonium compounds, from the group of the carboxylates, of the alkylsulfates, of the alkylsulfonates, of the alkylphosphates, of the alkylphosphonates, of the alkyl- and dialkylsulfosuccinates, and the respective corresponding free acids, from the group of the silicones, from the group or the silanes, from the group of the epoxides and/or isocyanates.

Particles having reactive OH, NH or NH2 groups at the surface may preferably be modified with hydrophobizing agents reactive toward these groups, such as preferably silanes, silazanes, epoxides, isocyanates, carboxylic anhydrides, carbonyl chlorides and/or alkyl chlorides, with especial preference in this context for silanes and/or silazanes.

In a particularly preferred embodiment of the invention, solids-based foaming aids used are silicon dioxide, aluminium oxide and/or silicates, preferably sheet silicates, especially kaolin, and hydrophobizing agents used are amines or cations thereof, quaternary ammonium compounds, for example palmitamidopropyltrimonium chloride, alkylsulfates or silanes, where the solids-based foaming aid may be hydrophobized beforehand or in situ, as elucidated hereinafter. The use of solids-based foaming aids that have been hydrophobized beforehand is very particularly preferred here. The use of solids-based foaming aids that have been hydrophobized in situ is likewise particularly preferred.

The optional, preferably mandatory, hydrophobization of the particles used as foaming aids may be effected here separately, i.e. actually prior to the addition of the particles used as foaming aids to the aqueous polymer dispersion, or in situ, i.e. directly within the aqueous polymer dispersion. In the case of separate hydrophobization, particles and hydrophobizing agent, prior to addition to the polymer dispersion, are formulated to give a one-component system that is then added to the polymer dispersion. This can be effected either in pure form or in a suitable solvent or dispersant, with particular preference for water as solvent or dispersant. In the case of in situ hydrophobization, particles and hydrophobizing agent are added to the polymer dispersion as individual components. Here too, it is possible to add particles and hydrophobization agent to the polymer dispersion each in pure form or each as a solution or dispersion, preference being given especially to aqueous solutions and dispersions.

It may be necessary to pretreat the surface of the particles before the actual hydrophobization in order to achieve sufficient interaction between particles and hydrophobizing agent. For example, in the case of aqueous particle dispersions, the surface charge of the particles may be adjusted by varying the pH. In the case of permanent covalent modification of the particles, it may be necessary, moreover, to accelerate the reaction between particles and hydrophobizing agent by selection of suitable reaction parameters, for example by heating, by distilling off volatile reaction byproducts or by using suitable catalysts in order thus to arrive at sufficient hydrophobization of the particles.

In the case of hydrophobized or partly hydrophobized particles, it is preferable in the context of the present invention when the hydrophobizing agents are used in a concentration of 0.01-50% by weight, preferably 0.02-25% by weight, more preferably in the range of 0.03-20% by weight, even more preferably in the range of 0.04-15% by weight, even more preferably in the range of 0.05-10% by weight, based on the total amount of particles and hydrophobizing agents.

As already described, the present invention envisages the use of solids-based foaming aids, as described above, in aqueous polymer dispersions, preferably in aqueous polyurethane dispersions. The polymer dispersions here are preferably selected from the group of aqueous polystyrene dispersions, polybutadiene dispersions, poly(meth)acrylate dispersions, polyvinyl ester dispersions and/or polyurethane dispersions, and dispersions of combinations of polymers mentioned or mixed dispersions. The solids content of these dispersions is preferably in the range of 20-70% by weight, more preferably in the range of 25-65% by weight, based on the overall dispersion. Particular preference is given in accordance with the invention to the use of solids-based foaming aids in aqueous polyurethane dispersions. Especially preferable here are polyurethane dispersions based on polyester polyols, polyesteramide polyols, polycarbonate polyols, polyacetal polyols and/or polyether polyols.

In the context of the present invention, it is preferable when the concentration of the solids-based foaming aids, based on the total weight of the aqueous polymer dispersion, is in the range of 0.1-50% by weight, more preferably in the range of 0.5-40% by weight, especially preferably in the range of 1.0-35% by weight.

As described above, the present invention envisages the use of solids-based foaming aids in aqueous polymer dispersions. In this context, the solids-based foaming aids can firstly enable efficient foaming of the polymer dispersion and secondly enable the formation of a stable and simultaneously fine-cell and homogeneous foam. The solids-based foaming aids can thus act as foam former or foam stabilizer. These terms may be used synonymously for the term “foaming aids”. The person skilled in the art will be able to verify the fine-cell character of the foam in a customary manner by simple direct visual inspection by the naked eye or with optical aids, for example magnifying glasses, microscopes, drawing on their customary experience. “Fine cells” relates to cell size. The smaller the average cell size, the finer the foam. If appropriate, the fine cell content can be determined, for example, with a light microscope or with a scanning electron microscope. “Homogeneous” means the cell size distribution. A homogeneous foam has a very narrow cell size distribution, such that all cells are about the same size. This could in turn be quantified with a light microscope or with a scanning electron microscope. The lesser the degree of variation in the fine-cell character and homogeneity of the foam with time, especially in the course of drying of the foam at elevated temperatures, the more stable the foam. As well as this purpose, the solids-based foaming aids may additionally serve as drying aids, rheology additives or fillers, which likewise corresponds to preferred embodiments of the present invention. Use of fillers in dispersions for production of porous polymer coatings is known. One way in which the solids-based foaming aids according to the invention differ from mere fillers is that they are more hydrophobic, or are rendered more hydrophobic, optionally in situ, and hence enable an improvement in foam quality within the scope of the aforementioned parameters and make a very positive contribution to the foamability of the system.

As well as the solids-based foaming aids according to the invention, the aqueous polymer dispersions may also comprise further additions/formulation components such as colour pigments, further fillers, flatting agents, stabilizers such as hydrolysis or UV stabilizers, antioxidants, absorbers, crosslinkers, levelling additives, thickeners and further interface-active substances. It is a particularly preferred embodiment of the present invention when the aqueous polymer dispersions, as well as the solids-based foaming aid according to the invention, contain less than 2% by weight, preferably less than 1% by weight, more preferably less than 0.5% by weight, even more preferably less than 0.1% by weight, even more preferably none at all, of further foaming aids, foam stabilizers, foam formers or foam additives, especially none based on ammonium stearate.

As already mentioned, the solids-based foaming aids and any hydrophobizing agents used in the aqueous polymer dispersion may either be in pure form or in predispersed or predissolved form in a suitable dispersion medium or solvent. In the case of in situ modification of the particles used as foaming aid, it is additionally possible to disperse or to dissolve one of the two components in a suitable dispersion medium or solvent and to add the other component in pure form to the aqueous polymer dispersion. Preferred dispersion media or solvents in this connection are selected from water, propylene glycol, dipropylene glycol, polypropylene glycol, butyldiglycol, butyltriglycol, ethylene glycol, diethylene glycol, polyethylene glycol, polyalkylene glycols based on EO, PO, BO and/or SO, alcohol alkoxylates based on EO, PO, BO and/or SO, and mixtures of these substances, very particular preference being given to aqueous dispersions and solutions.

If the solids-based foaming aids according to the invention are added to the aqueous polymer dispersion not in pure form but as a dispersion, it may, moreover, the advantageous when corresponding dispersions contain further formulating aids, for example dispersing or rheology additives. This too is a preferred embodiment of the present invention.

Since, as described above, the inventive use of solids-based foaming aids leads to a considerable improvement in porous polymer coatings produced from aqueous polymer dispersions, the present invention likewise provides aqueous polymer dispersions comprising at least one of the solids-based foaming aids according to the invention, as described in detail above.

Yet another subject of the present invention is porous polymer layers produced from aqueous polymer dispersions, obtained with the inventive use of solids-based foaming aids, as described in detail above, wherein the solids content of these dispersions is preferably in the range of 20-70% by weight, more preferably in the range of 25-65% by weight, based on the overall dispersion, and wherein the concentration of the solids-based foaming aids, based on the total weight of the aqueous polymer dispersion, is preferably in the range of 0.1-50% by weight, more preferably in the range of 0.5-40% by weight, especially preferably in the range of 1.0-35% by weight.

Preferably, the porous polymer coatings according to the invention can be produced by a method using preferably hydrophobized or partly hydrophobized solids-based foaming aids as additives in aqueous polymer dispersions, preferably as described above, the method comprising the steps of:
a) providing a mixture comprising at least one aqueous polymer dispersion, at least one solids-based foaming aid, and optionally further additives,
b) foaming the mixture to give a foam,
c) optionally adding at least one thickener to adjust the viscosity of the wet foam,
d) applying a coating of the foamed polymer dispersion to a suitable carrier,
e) drying the coating.

This process for producing a porous polymer coating, preferably porous polyurethane coating, using preferably hydrophobized or partly hydrophobized solids-based foaming aids as additives in aqueous polymer dispersions, preferably aqueous polyurethane dispersions, preferably as described above, forms a further part of the subject-matter of the invention. The solids-based foaming aid used in step a) is preferably hydrophobized or partly hydrophobized, where the hydrophobization of the solids-based foaming aid can be effected beforehand or in situ, as described above.

With regard to preferred configurations, especially with regard to the solids-based foaming aids and polymer dispersions that are usable with preference in the process, reference is made to the preceding description and also to the aforementioned preferred embodiments, especially as detailed in the claims.

It is made clear that the process steps of the process according to the invention as set out above are not subject to any fixed sequence in time. For example, process step c) can be executed at an early stage, at the same time as process step a).

It is a preferred embodiment of the present invention when, in process step b), the aqueous polymer dispersion is foamed by the application of high shear forces. The foaming can be effected here with the aid of shear units familiar to the person skilled in the art, for example Dispermats, dissolvers, Hansa mixers or Oakes mixers. The aim is preferably to arrive at foams of maximum fine-cell character and maximum homogeneity in step b).

In addition, it is preferable when the wet foam produced at the end of process step c) has a viscosity of at least 5, preferably of at least 10, more preferably of at least 15 and even more preferably of at least 20 Pa·s, but of not more than 500 Pa·s, preferably of not more than 300 Pa·s, more preferably of not more than 200 Pa·s and even more preferably of not more than 100 Pa·s. The viscosity of the foam can be determined here preferably with the aid of a Brookfield viscometer, LVTD model, equipped with an LV-4 spindle. Corresponding test methods for determination of the wet foam viscosity are known to those skilled in the art.

As already described above, additional thickeners can optionally be added to the system to adjust the wet foam viscosity.

Preferably, the optional thickeners which can be used advantageously in the context of the invention are selected here from the class of the associative thickeners. Associative thickeners here are substances which lead to a thickening effect through association at the surfaces of the particles present in the polymer dispersions or through association to form networks. The term is known to those skilled in the art. Preferred associative thickeners are selected here from polyurethane thickeners, hydrophobically modified polyacrylate thickeners, hydrophobically modified polyether thickeners and hydrophobically modified cellulose ethers. Very particular preference is given to polyurethane thickeners. In addition, it is preferable in the context of the present invention when the concentration of the optionally usable thickeners based on the overall composition of the dispersion is in the range of 0.01-10% by weight, more preferably in the range of 0.05-5% by weight, most preferably in the range of 0.1-3% by weight.

In the context of the present invention, it is additionally preferable when, in process step d), coatings of the foamed polymer dispersion with a layer thickness of 10-10 000 μm, preferably of 50-5000 μm, more preferably of 75-3000 μm, even more preferably of 100-2500 μm, are produced. Coatings of the foamed polymer dispersion can be produced by methods familiar to the person skilled in the art, for example knife coating. It is possible here to use either direct or indirect coating processes (so-called transfer coating).

It is also preferable in the context of the present invention when, in process step e), the drying of the roamed and coated polymer dispersion is effected at elevated temperatures. Preference is given here in accordance with the invention to drying temperatures of min. 50° C., preferably of 60° C., more preferably of at least 70° C. In addition, it is possible to dry the foamed and coated polymer dispersions in multiple stages at different temperatures, in order to avoid the occurrence of drying defects. Corresponding drying techniques are widespread in the industry and are known to those skilled in the art.

As already described, process steps c)-e) can be effected with the aid of widely practised methods known to those skilled in the art. An overview of these is given, for example, in “Coated and laminated Textiles” (Waiter Fung, CR-Press, 2002).

In the context of the present invention, preference is given especially to those porous polymer coatings comprising the solids-based foaming aids and having an average cell size less than 350 μm, preferably less than 200 μm, especially preferably less than 150 μm, most preferably less than 100 μm. The average cell size can preferably be determined by microscopy, preferably by electron microscopy. For this purpose, a cross section of the porous polymer coating is viewed by means of a microscope with sufficient magnification and the size of at least 25 cells is ascertained. In order to obtain sufficient statistics for this evaluation method, the magnification of the microscope chosen should preferably be such that at least 10×10 cells are present in the observation field. The average cell size is then calculated as the arithmetic average of the cells or cell sizes viewed. This determination of cell size by means of microscopy is familiar to those skilled in the art.

The invention thus further provides a porous polymer coating, preferably porous polyurethane coating, obtainable by the use of hydrophobized or partly hydrophobized solids-based foaming aids as additives in aqueous polymer dispersions, preferably aqueous polyurethane dispersions, in the production of such polymer coatings, preferably obtainable by a process as described above.

The porous polymer layers (or polymer coatings) according to the invention, comprising at least one of the preferably hydrophobized solids-based foaming aids according to the invention according to the invention and optionally further additives, may be used, for example, in the textile industry, for example for imitation leather materials, in the construction industry, in the electronics industry, in the sports industry or in the automobile industry. For instance, it is possible on the basis of the porous polymer coatings according to the invention to produce everyday articles, for example shoes.

The invention therefore further provides everyday articles comprising a porous polymer coating as described above, preferably shoes, insoles, bags, suitcases, small cases, clothing, automobile parts, preferably seat covers, coverings of door parts, dashboard parts, steering wheels and/or handles, and gearshift gaiters, fitout articles such as desk pads, cushions or seating furniture, gap fillers in electronic devices, cushioning and damping materials in medical applications, and/or adhesive tapes.

### EXAMPLES

### Substances:

IMPRANIL® DLU: aqueous aliphatic polycarbonate ester-polyether-polyurethane dispersion from Covestro,
REGEL® WX 151: aqueous polyurethane dispersion from Cromogenia,
CROMELASTIC® PC 287 PRG: aqueous polyurethane dispersion from Cromogenia,
CROMELASTIC® PS 075: aqueous aliphatic polyester-polyol polyurethane dispersion from Cromogenia,
KT 738: aqueous aliphatic polyurethane dispersion from Scisky,
KT 650: aqueous aliphatic polyurethane dispersion from Scisky,
Kaolin: pulverulent kaolin having a particle size in the range of 1-20 μm (measured with a Mastersizer 3000 from Malvern), purchased from Sigma Aldrich,
VARIFSOFT® PATC: palmitamidopropyltrimonium chloride from Evonik Industries AG,
STOKAL® STA: ammonium stearate (about 30% in H₂O) from Bozetto.
STOKAL® SR: tallow fat-based sodium sulfosuccinamate (about 35% in H₂O) from Bozetto,
ECO Pigment Black: aqueous pigment dispersion (black) from Cromogenia.
TEGOWET® 250: polyethersiloxane-based levelling additive from Evonik industries AG,
ORTEGOL® PV 301: polyurethane-based associative thickener from Evonik industries AG,
REGEL® TH 27: isocyanate-based crosslinking additive from Cromogenia,
LUDOX® HS 40: colloidal dispersion of unmodified silica particles (mean particle size=12 nm; solids portion=40% by weight) from Grace,
AEROSIL® R 812 S: pyrogenic silica, surface-modified with hexamethyidisilazane (CAS: 68909-20-6) from Evonik.

### Viscosity Measurements:

All viscosity measurements were conducted with a Brookfield viscometer, LVTD, equipped with an LV-4 spindle, at a constant rotation speed of 12 rpm. For the viscosity measurements, the samples were transferred into a 100 ml jar into which the measurement spindle was immersed. The display of a constant viscometer measurement was always awaited.

### Example 1: Foaming Tests with Hydrophobized Kaolin

In this test series, palmitamidopropyltrimonium chloride-hydrophobized kaolin was used as solids-based foaming aid. The hydrophobization took place in situ here; in other words, kaolin and palmitamidopropyltrimonium chloride (VARISOFT® PATC) were added to the aqueous polyurethane dispersion as separate components.

The efficacy of this solids-based foaming aid was tested by conducting a series of foaming experiments. For this purpose, in a first step, the IMPRANIL® DLU polyurethane dispersion from Covestro was used. This was a foamed using palmitamidopropyltrimonium chloride-hydrophobized kaolin (experiment #3). In addition, two comparative tests were conducted, in each of which just one of the two individual components, i.e. solely palmitamidopropyltrimonium chloride (experiment #1) or kaolin (experiment #2), was used. Moreover, two comparative tests were conducted using ammonium stearate-based foaming aids, one in a kaolin-free polyurethane dispersion (experiment #4) and one in a kaolin-containing polyurethane dispersion. These experiments demonstrate the improved efficacy of the solids-based foaming aids according to the invention compared to the prior art. Table 1 gives an overview of the compositions of the respective experiments.

All foaming experiments were conducted manually. For this purpose, all components except for the ORTEGOL® PV 301 rheology additive were first placed in a 500 ml plastic cup and homogenized with a dissolver equipped with a disperser disc (diameter=6 cm) at 1000 rpm for 3 min. For foaming of the mixtures, the stirrer speed was then increased to 2000 rpm, ensuring that the disperser disc was always immersed into the dispersion to a sufficient degree that a proper vortex formed. At this speed, the mixtures were foamed to a volume of about 425 ml. Subsequently, ORTEGOL® PV 301 was added to a mixture with a syringe and the mixture was stirred at 1000 rpm for a further 15 minutes. In this step, the disperser disc was immersed sufficiently deeply into the mixtures that no further air was introduced into the system, but the complete volume was still in motion.

TABLE 1
Overview of foam formulations:

| | #1 | #2 | #3 | #4 | #5 |
|---|---|---|---|---|---|
| IMPRANIL ® DLU | 125 g | 125 g | 125 g | 125 g | 125 g |
| Kaolin | 25 g | — | 25 g | | 25 g |
| VARISOFT ® PATC | — | 5 g | 5 g | | |
| (20% soln. in H₂O) | | | | | |
| ORTEGOL ® PV 301 | 1 g | 1 g | 1 g | 1 g | 1 g |
| Stokal STA | — | — | — | 2 g | 2 g |
| Stokal SR | — | — | | 2 g | 2 g |
| Wet foam viscosity [mPa s] | 8600 | 4200 | 19700 | 7500 | 13000 |

In the foaming of the mixtures, it was noticeable that the polyurethane dispersion containing kaolin only (experiment #1) was barely foamable. The target volume of 425 ml was not attained. The dispersion containing palmitamidopropyltrimonium chloride only (experiment #2) had good foamability, but a coarse, irregular and mobile foam was obtained at the end of the foaming operation. In the case of the polyurethane dispersion that contained the palmitamidopropyltrimonium chloride-hydrophobized kaolin according to the invention (experiment #3), a very fine and homogeneous foam having high viscosity was obtained at the end of the foaming operation. Compared to the two foams that contained ammonium stearate as roaming aid (experiments #4 and #5), this foam was much finer and more homogeneous.

All foams were subsequently applied to a siliconized polyester film with the aid of a film applicator (AB3220 from TQC) equipped with an applicator frame (film thickness=800 μm) and the coating was dried at 60° C. for 5 min and at 120° C. for a further 5 min.

In the case of the system that contained kaolin only (experiment #1), after drying, a compact coating that contained only a few large inclusions of air was obtained. As a result, the coating imparted a very rigid, not very flexible tactile impression. The system containing palmitamidopropyltrimonium chloride only (experiment #2), after coating and drying, resulted in an inhomogeneous foam with coarse cells, which additionally had clear drying cracks. The tactile impression of this sample was inferior. By contrast, in inventive experiment #3, an optically homogeneous, fine-cell foam coating was obtained, which was free of defects. The coating had a very silky, supple handle. Compared to the two comparative samples #4 and #5 that contained ammonium stearate as foaming aids, the inventive coating #3 had a more homogeneous appearance; its tactile impression was additionally better. In electron microscopy studies, the comparison of all samples additionally showed that inventive sample #3 had the finest pore structure.

These experiments thus impressively demonstrate the excellent effect of hydrophobized particles as solids-based foaming aids in aqueous polyurethane dispersions. Thus, in the case of hydrophobized particles (experiment #3), it was possible to achieve a much better result than was possible with the two individual components (pure kaolin, pure hydrophobizing agent). In addition, it was possible to show an improved effect compared to the prior art.

### Example 2: Migration Tests

The surface migration of the solids-based foaming aid was assessed by producing imitation leather materials by the method that follows. First of all, a topcoat coating was applied to a siliconized polyester film (layer thickness 100 μm). This was then dried at 100° C. for 3 minutes. Subsequently, a foam layer was coated onto the dried topcoat layer (layer thickness 800 μm) and dried at 60° C. for 5 minutes and at 120° C. for 5 minutes. In a last step, an aqueous adhesive layer (layer thickness 100 μm) was coated onto the dried foam layer, and then a textile carrier was laminated onto the still-moist adhesive layer. The finished laminate was dried again at 120° C. for 5 minutes and then detached from the polyester film.

All coating and drying operations were performed here with a Labcoater LTE-S from Mathis AG. Topcoat and adhesive layer were formulated here in accordance with the compositions listed in Table 2; the foam layers used were the foam formulations #3, #4 and #5 listed in Table 1, which were foamed by the method described in Example 2.

For assessment of surface migration, the imitation leather samples, after production, were placed into water at 100° C. for 30 minutes and then dried at room temperature overnight. After this treatment, the comparative sample produced from the Stokal STA/SR surfactants (foam formulation #4 and #5, Table 1) had distinctly visible white spots on the surface of the imitation leather, whereas this surface discoloration was not observed in the samples produced with the solids-based foaming aids according to the invention (formulation #3, Table 1).

TABLE 2
Topcoat and adhesive formulation for
production of imitation leather materials:

| | Topcoat | Adhesive |
|---|---|---|
| CROMELASTIC ® PC 287 PRG | 100 g | — |
| REGEL ® WX 151 | — | 100 g |
| ECO Pigment Black | 10 g | 5 g |
| TEGOWET ® 250 | 0.2 g | 0.2 g |
| REGEL ® TH 27 | 6 g | 6 g |
| ORTEGOL ® PV 301 | 7 g | 5 g |

### Example 3: Foaming Experiments with Hydrophobized Fumed Silica Particles

In a further series of experiments, AEROSIL® R 512 S (hydrophobized fumed silica particles) was used as solids-based foaming said in various PUD systems. Table 3 gives an overview of the foam formulations used for this purpose:

TABLE 3
Foam formulations containing AEROSIL ® R
812 S as solids-based foaming aid

| | #6 | #7 | #8 |
|---|---|---|---|
| CROMELASTIC ® PS 075 | 150 g | — | — |
| KT 736 | — | 150 g | — |
| KT 650 | — | — | 150 g |
| AEROSIL ® R 812 S | 1 g | 1 g | 1 g |
| ORTEGOL ® PV 301 | 1 g | 1 g | 1 g |
| Wet foam viscosity [mPa s] | 11200 | 13000 | 16100 |

These formulations, by the method described in Example 1, were foamed to a volume of about 300 ml and then applied with the aid of a film applicator (AB3220 type from TQC) equipped with an applicator frame (film thickness=800 μm) to a siliconized polyester film, and the coating was dried at 60° C. for 5 min and at 120° C. for a further 5 min.

In all these experiments, it was observed that the use of Aerosil® R 812 enabled rapid and efficient foaming of the formulations. After the foaming, in all cases, homogeneous stable films were obtained, which could subsequently be dried to give a defect-free coating. These experiments thus also demonstrate the good effect of hydrophobized particles as foam stabilizer in aqueous polyurethane dispersions.

### Example 4: Foaming Experiments with Hydrophobized Colloidal Silica Particles

In this series of experiments, colloidal silica particles that had been hydrophobized with palmitamidopropyltrimonium chloride were used as solids-based foaming aid. The hydrophobization took place in situ here, i.e. silica particles and palmitamidopropyltrimonium chloride (VARISOFT® PATC) were added as separate components to the aqueous polyurethane dispersion. The silica particles used here were the silica dispersion LUDOX® HS 40.

TABLE 4

| | #6 | #7 | #8 |
|---|---|---|---|
| CROMELASTIC ® PS 075 | 150 g | — | — |
| KT 736 | — | 150 g | — |
| KT 650 | — | — | 150 g |
| LUDOX ® HS 40 | 3 g | 3 g | 3 g |
| VARISOFT ® HS 40 | 0.4 | 0.6 | 0.3 |
| ORTEGOL ® PV 301 | 1 g | 1 g | 1 g |
| Wet foam viscosity [mPa s] | 11200 | 13000 | 16100 |

These formulations, by the method described in Example 1, were foamed to a volume of about 300 ml and then applied with the aid of a film applicator (AB3220 type from TOC) equipped with an applicator frame (film thickness=800 μm) to a siliconized polyester film, and the coating was dried at 60° C. for 5 min and at 120° C. for a further 5 min.

In these experiments too, it was observed that the use of the hydrophobized silica particles enabled efficient foaming of the PU dispersions. In this series of experiments too, homogeneous stable foams were thus obtained, which could subsequently be dried to give a defect-free coating. These results thus underline the advantages of the present invention.

1. A method for producing a porous polymer coating, the method comprising:
foaming at least one solids-based foaming aid with an aqueous polymer dispersions, for production of a porous polymer coatings.

2. The method according to claim 1, wherein the at least one solids-based foaming aid consists of particles that are insoluble in the aqueous polymer dispersion.

3. The method according to claim 1, wherein the particles used s the at least one solids-based foaming aid have an average primary particle size in a range of 0.01-100 μm, determined via laser diffraction or dynamic light scattering.

4. The method according to claim 1, wherein the particles used as the at least one solids-based foaming aid are hydrophobized or partly hydrophobized.

5. The method according to claim 4, wherein a hydrophobizing agent used for the hydrophobization of the particles used as the at least one solids-based foaming aid are selected from the group consisting of cationic polymers of amines, quaternary ammonium compounds, carboxylates, alkylsulfates, alkylsulfonates, alkylphosphates, alkylphosphonates, alkyl- and dialkylsulfosuccinates, respective corresponding free acids, silicones, silanes, epoxides, and the isocyanates.

6. The method according to claim 5, wherein the hydrophobizing agent is used in a concentration of 0.01-50% by weight, based on the total amount of particles and the hydrophobizing agent.

7. The method according to claim 4, wherein the hydrophobization of the at least one solids-based foaming aid precedes the addition to the aqueous polymer dispersion and/or the hydrophobization of the at least one solids-based foaming aid is effected in situ, i.e. actually within the aqueous polymer dispersion.

8. The method according to claim 1, wherein the aqueous polymer dispersion is selected from the group consisting of aqueous polystyrene dispersions, polybutadiene dispersions, poly(meth)acrylate dispersions, polyvinylester dispersions and polyurethane dispersions, mixtures of these dispersions, and dispersions containing copolymers of the polymers mentioned.

9. The method according to claim 1, wherein the concentration of the at least one solids-based foaming aid based on the total weight of the aqueous polymer dispersion is in a range of 0.1-50% by weight.

10. The method e according to claim 5, wherein the at least one solids-based foaming aid is silicon dioxide, aluminium oxide and/or silicates, and the hydrophobizing agent used is an amine or a cation thereof, a quaternary ammonium compound, and wherein the at least one solids-based foaming aid may be hydrophobized beforehand or in situ.

11. An aqueous polymer dispersion, comprising:
at least one solids-based foaming aid, wherein the at least one solids-based foaming aid is a hydrophobized or partly hydrophobized solids-based foaming aid.

12. A process for producing a porous polymer coating, the process comprising:
a) providing a mixture comprising at least one aqueous polymer dispersion, at least one solids-based foaming aid, and optionally further additives,
b) foaming the mixture to give a foam,
c) optionally adding at least one thickener to adjust the viscosity of the wet foam,
d) applying a coating of the foamed polymer dispersion to a suitable carrier,
e) drying the coating.

13. The process according to claim 12, wherein the solids-based foaming aid used in a) is hydrophobized or partly hydrophobized, where the solids-based foaming aid may be hydrophobized beforehand or in situ in the aqueous polymer dispersion.

14. A porous polymer coating, comprising:
at least one hydrophobized or partly hydrophobized solids-based foaming aid as additives in aqueous polymer dispersions.

15. An article, comprising:
a porous polymer coating according to claim 14, wherein the article includes shoes, insoles, bags, suitcases, small cases, clothing, automobile parts, fitout articles, gap fillers in electronic devices, cushioning and damping materials in medical applications, and/or adhesive tapes.

16. The method according to claim 1, wherein the aqueous polymer dispersion is an aqueous polyurethane aqueous dispersion.

17. The method according to claim 2, wherein the at least one solids-based foaming aid consists of particles that are insoluble in the aqueous polyurethane dispersion, wherein organic particles are selected from the group consisting of cellulose, cellulose derivatives, chemical pulp, lignin, polysaccharides, wood fibres, sawdust, ground plastics, textile fibres and/or synthetic polymer particles, and wherein inorganic particles are selected from the group consisting of (mixed) oxides/hydroxides, carbonates, phosphates, sulfates, silicates, and silicone-based particles.

18. The method according to claim 5, wherein where the choice of the suitable hydrophobizing agent is directed by the surface properties of the particles to be hydrophobized, with particles having negative (partial) charges at the surface being modified by the hydrophobizing agent that bears cationic or partially cationic anchor groups, and with particles having positive (partial) charges at the surface being modified with the hydrophobizing agent that bears anionic or partially anionic anchor groups, and with particles having reactive OH, NH or NH2 groups at the surface being modified with the hydrophobizing agent reactive toward silanes and/or silazanes.

19. The method according to claim 6, wherein the concentration of the hydrophobizing agent is in the range of 0.05-10% by weight, based on the total amount of particles and the hydrophobizing agent.

20. The method according to claim 10, wherein the solids-based foaming aid is kaolin.
